(19) United States
(12) Patent Application Publication
(10) Pub. No.: US 2008/0276067 A1
(43) Pub. Date: Nov. 6, 2008

(54) Method and Apparatus for Page Table Pre-Fetching in Zero Frame Display Channel

(75) Inventors: Ping Chen, San Jose, CA (US); Roy Kong, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Hsin-Tien (TW)

(21) Appl. No.: 11/742,747

(22) Filed: May 1, 2007

(51) Int. Cl. G06F 9/26

(52) U.S. Cl. 711/206

(57) ABSTRACT

A method for a graphics processing unit (“GPU”) to maintain a local cache to minimize system memory reads is provided. A display read request and a logical address are received. The GPU determines whether a local cache contains a physical address corresponding to the logical address. If not, a cache fetch command is generated, and a number of cache lines is retrieved from a table, which may be a GART table, in the system memory. The logical address is converted to a corresponding physical address of the memory when the cache lines are retrieved from the table so that data in memory may be accessed by the GPU. When a cache line in the local cache is consumed, a next line cache fetch request is generated to retrieve a next cache line from the table so that the local cache maintains a predetermined amount of cache lines.

### TECHNICAL FIELD

The present disclosure relates to graphics processing, and more particularly, to a method and apparatus for pre-fetching page table information in zero and/or low frame buffer applications.

### BACKGROUND

Current computer applications are generally more graphically intense and involve a higher degree of graphics processing power than their predecessors. Applications, such as games, typically involve complex and highly detailed graphics renderings that involve a substantial amount of ongoing computations. To match the demands made by consumers for increased graphics capabilities in computing applications, like games, computer configurations have also changed.

As computers, particularly personal computers, have been programmed to handle programmer's ever increasingly demanding entertainment and multimedia applications, such as high definition video and the latest 3D games, higher demands have likewise been placed on system bandwidth. Thus, methods have arisen to deliver the bandwidth needed for such bandwidth hungry applications, as well as providing additional bandwidth headroom for future generations of applications. Plus, the structures of graphics processing units in computers have been also changing and improving in attempt to not only keep pace, but to stay ahead as well.

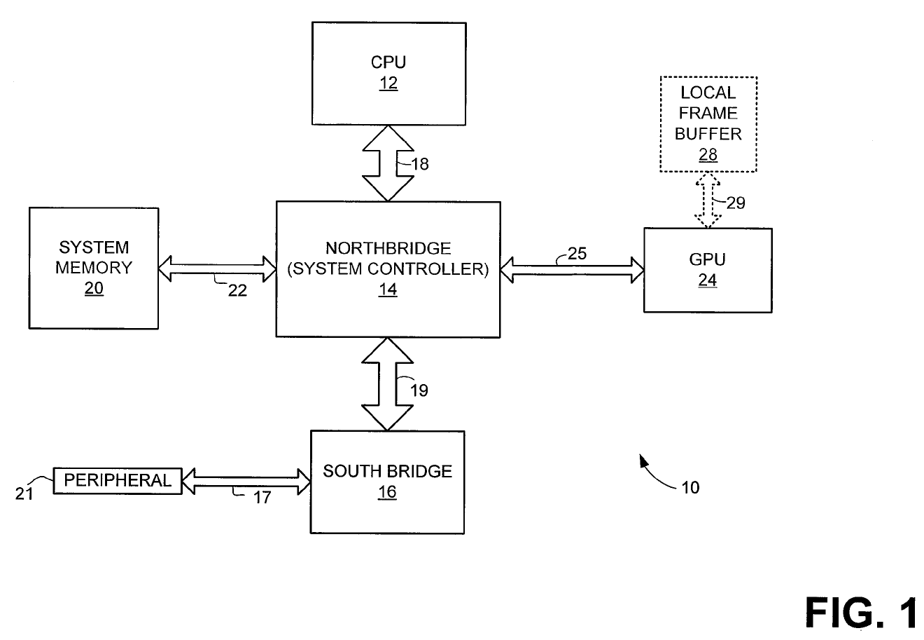

FIG. 1 is a diagram of a portion of a computing system 10, as one of ordinary skill in the art would know. Computing system 10 includes a CPU 12 coupled via high-speed bus, or path, 18 to a system controller, or northbridge 14. One of ordinary skill in the art would know that northbridge 14 may serve as a system controller for coupling system memory 20 and graphics processing unit (“GPU”) 24, via high speed data paths 22 and 25, which, as a nonlimiting example, may each be a peripheral component interconnect express (“PCIe”) bus. The northbridge 14 may also be coupled to a south bridge 16 via high-speed data path 19 to handle communications between each component coupled thereto. The south bridge 16 may be coupled via bus 17, as a nonlimiting example, to one or more peripherals 21, which may be configured as one or more input/output devices.

Returning to northbridge 14, GPU 24 may be coupled via PCIe bus 25, as previously described above. GPU 24 may include a local frame buffer 28, as shown in FIG. 1. Local frame buffer 28 may be sized as a 512 MB buffer, as a nonlimiting example, or some other configuration, as one of ordinary skill in the art would know. However, local frame buffer 28 may be some small sized buffer or may be omitted completely in some configuration.

GPU 24 may receive data from system memory 20 via northbridge 14 and PCIe buses 22 and 25, as shown in FIG. 1. GPU 24 may follow commands received from the CPU 12 to generate graphical data, which may then be stored in either the local frame buffer 28, if present and sufficiently sized, or in system memory 20, for ultimate presentation on a display device, which also may be coupled to computing system 10, as one of ordinary skill in the art would know.

Local frame buffer 28 may be coupled to GPU 24 for storing part or even all of display data. Local frame buffer 28 may be configured to store information such as texture data and/or temporary pixel data, as of one of ordinary skill in the art would know. GPU 24 may be configured to exchange information with local frame buffer 28 via a local data bus 29, as shown in FIG. 1.

If local frame buffer 28 does not contain any data, GPU 24 may execute a memory reading command to access system memory 20 via the northbridge 14 and data paths 22 and 25. One potential drawback in this instance is that the GPU 24 may not necessarily access system memory 20 with sufficiently fast speed. As a nonlimiting example, if data paths 22 and 25 are not fast data paths, the accessing of system memory 20 is slowed.

To access data for graphical-oriented processing from system memory 20, GPU 24 may be configured to retrieve such data from system memory 20 using a graphics address remapping table (“GART”), which may be stored in system memory 20 or in the local frame buffer 28, if available. The GART table may contain references of physical addresses corresponding to virtual addresses.

If the local frame buffer 28 is unavailable, the GART table is thus stored in system memory 20. Thus, GPU 24 may execute a first retrieve operation to access data from the GART table in system memory 20 so as to determine the physical address for data stored in system memory 20. Upon receiving this information, the GPU 24 may thereafter retrieve the data at the physical address in the second retrieval operation. Therefore, if local frame buffer 28 is too small for storing the GART table or is nonexistent, then GPU 24 may rely more heavily on system memory 20, and therefore suffer increased latency times, resulting from multiple memory access operations.

Thus, to utilize a display with system memory 20, three basic configurations may be utilized. The first is a contiguous memory address implementation, which may be accomplished by using the GART table, as described above. With the GART table, the GPU 24 may be able to map various non-contiguous 4 kb system memory physical pages in system memory 20 into a larger continues logical address space for display or rendering purposes. As many graphic card systems, such as the computer system 10 in FIG. 1, may be equipped with an x16 PCI express link, such as PCIe path 25, to the northbridge 14, the bandwidth provided by the PCIe path 25 may be sufficiently adequate for communicating the corresponding amounts of data.

In a graphics system wherein the local frame buffer 28 is a sufficiently sized memory, the GART table may actually reside in the local frame buffer 28, as described above. The local drive bus 29 may therefore be used to fetch the GART table from the local frame buffer 28 so that address remapping may be performed by the display controller of GPU 24.

The read latency to the display in this instance (wherein the GART table is contained in local frame buffer 28) may be the summation of the local frame buffer 28 read time plus the time spent for the translation process. Since the local frame buffer 28 access may be typically be relatively fast compared to system memory 20 access, as described above, the impact on read latency is not overly great, as a result of the GART table fetch itself in this instance.

However, when there is no local frame buffer 28 in computing system 10, the GART table may be located in system memory 20, as also described above. Therefore, in order to perform a page translation (of a virtual address to a physical address), the table requests may be first issued by a bus interface unit of GPU 24. The display read address may then be translated and then a second read for the display data itself may be ultimately issued. In this case a single display read is realized as two bus interface unit system memory reads. Stated another way, read latency to the display controller of GPU 24 is double, which may not be acceptable for graphical processing operations.

Therefore, a heretofore unaddressed need exists to address the aforementioned deficiencies and shortcomings described above.

### SUMMARY

A method for a graphics processing unit (“GPU”) of a computer to maintain a local cache to minimize system memory reads is provided. The GPU may have a relatively small-sized local frame buffer or may lack a local frame buffer completely. In any instance, the GPU may be configured to maintain a local cache of physical addresses for display lines being executed so as to reduce the instances when the GPU attempts to access the system memory.

Graphics related software may cause a display read request and a logical address to be received by the GPU. In one nonlimiting example, the display read request and logical address may be received by a display controller in a bus interface unit (“BIU”) of the GPU. A determination may be made as to whether a local cache contains a physical address corresponding to the logical address received with the display read request. A hit/miss component in the BIU may make the determination.

If the hit/miss component determines that the local cache does contain the physical address corresponding to the received logical address, the result may be recognized as a “hit.” In that instance, the logical address may be thereafter converted to its physical address counterpart. The converted physical address may be forwarded by a controller to the system memory of the computer to access the addressed data. A northbridge may be positioned between the GPU and the system memory that routes communications therebetween.

However, if the hit/miss component determines that the local cache does not contain the physical address corresponding to the received logical address, a “miss” result may be recognized. In that instance, a miss pre-fetch component in the BIU may be configured to retrieve a predetermined number of cache pages from a table, such as a GART table in one nonlimiting example, stored in the system memory. In one nonlimiting example, a programmable register may control the quantity of the predetermined number of cache pages (or lines) that are retrieved from the table. In an additional nonlimiting example, the predetermined number of cache pages retrieved may be the quantity that corresponds to the number of pixels in one line of a display coupled to the GPU.

When the hit/miss test component determines that the local cache does contain the physical address corresponding to the received logical address, an additional evaluation may be made as to whether an amount of cache pages in the local cache is becoming low. If so, a hit prefetch component may generate a next cache page request, or the like, to retrieve a next available cache page from the table (i.e., GART table) in the system memory so as to replenish the amount of cache pages contained in the local cache. In this manner, the local cache may be configured to maintain a position that is sufficiently ahead of a current processing position of the GPU.

This configuration enables the GPU to minimize the number of miss determinations, thereby increasing the efficiency of the GPU. Efficiency is increased by the GPU not having to repeatedly retrieve both the cache pages containing physical addresses and the data itself from the system memory. Retrieving both the cache page containing the physical addresses and the addressed data thereafter constitutes two separate system memory access operations and is slower than if the system memory is accessed just once. Instead, by attempting to insure that the physical addresses for received logical addresses are contained in the local cache, the GPU accesses system memory once for actual data retrieval purposes, thereby operating more efficiently.

### DETAILED DESCRIPTION OF DRAWINGS

FIG. 1 is a diagram of a computing system with a GPU that may be configured to access data stored in system memory for graphical processing operations.

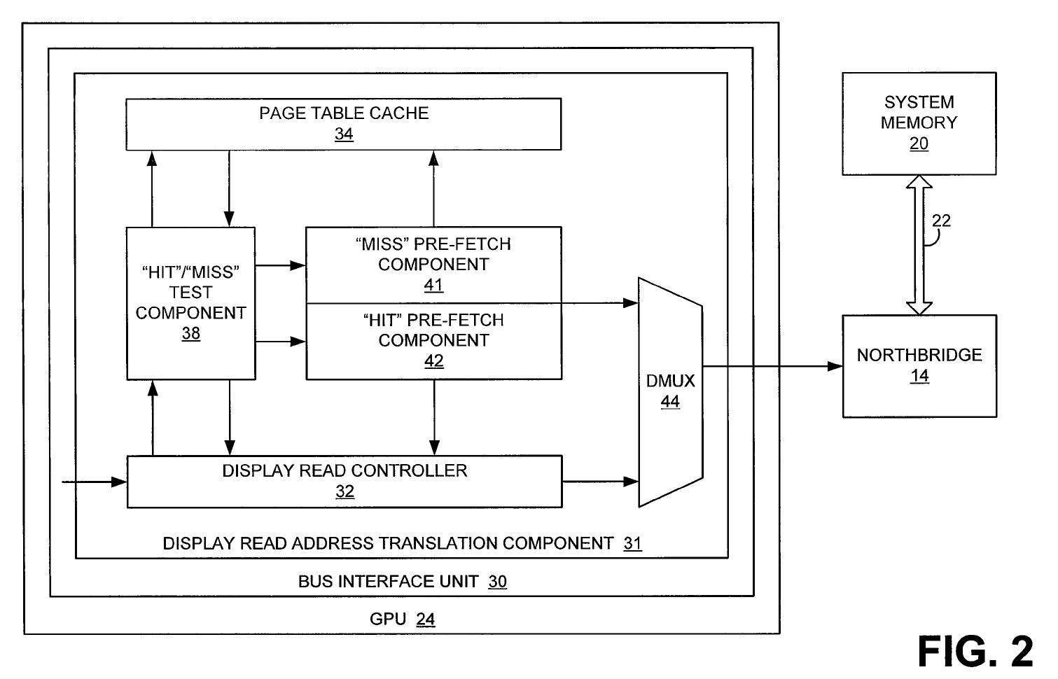

FIG. 2 is a diagram of the GPU of FIG. 1 with a display read address translation component shown for implementing pre-fetch operations to minimize access to the system memory of FIG. 1.

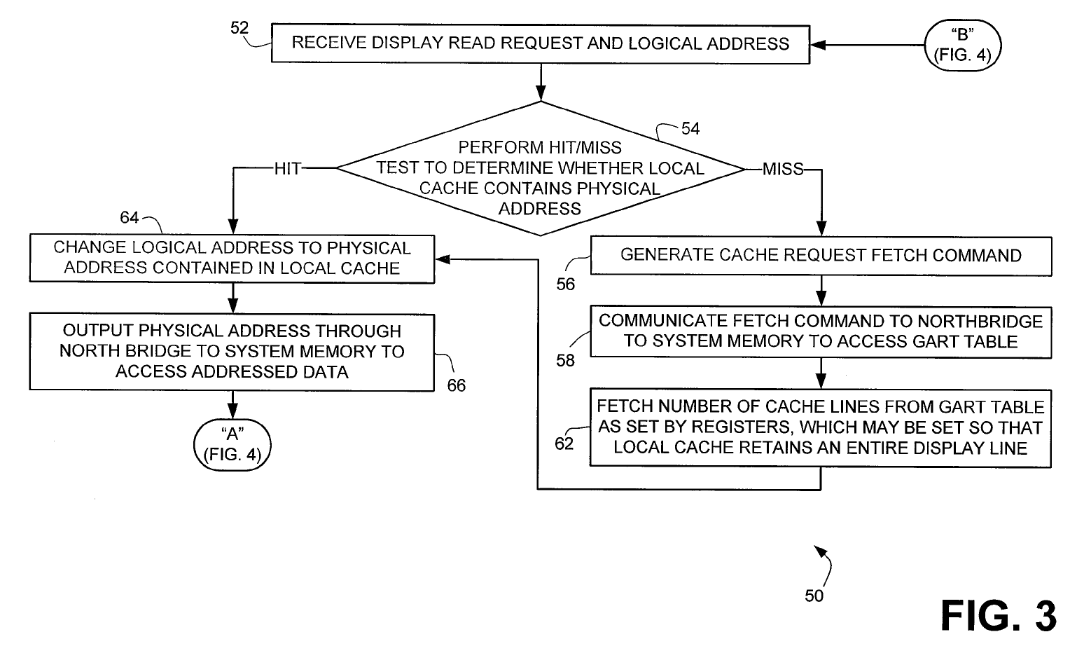

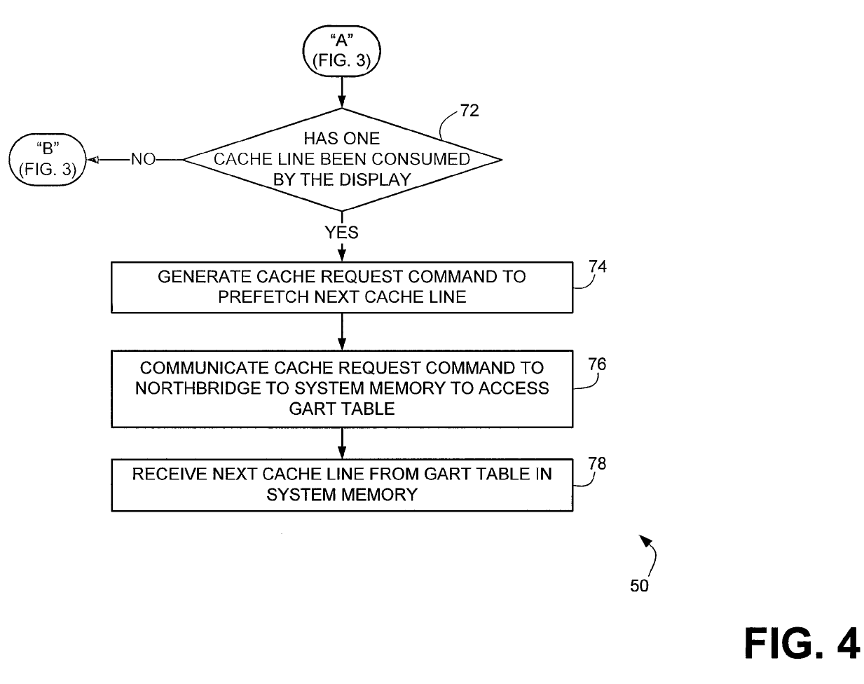

FIGS. 3 and 4 are flowchart diagrams of the steps that the GPU of FIGS. 1 and 2 may implement in order to determine whether to access system memory for pre-fetching operations.

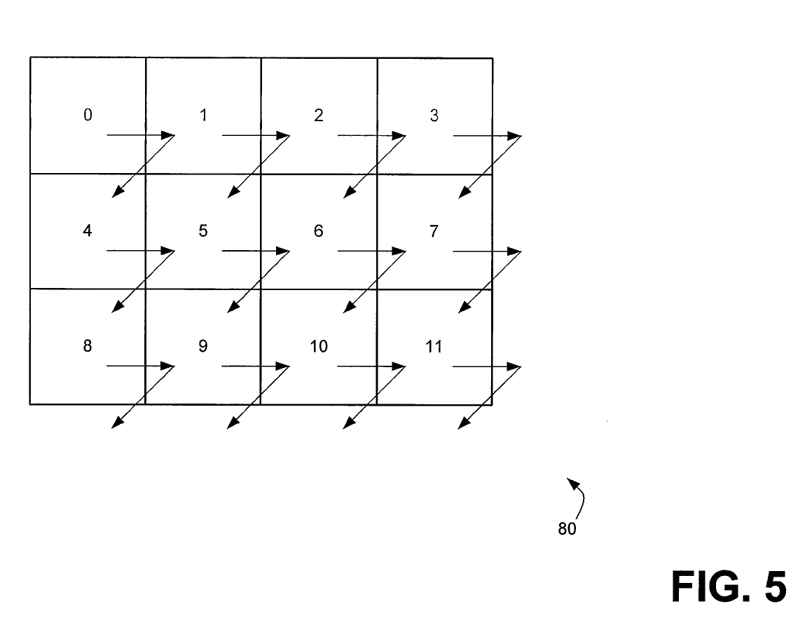

FIG. 5 is a graphical diagram depicting a process for the GPU of FIGS. 1 and 2 to pre-fetch cache lines from a GART table stored in the system memory of FIG. 1.

### DETAILED DESCRIPTION

As described above, the GPU 24 of FIG. 1 may be configured so as to minimize access of system memory 20 of FIG. 1, which may reduce read latency times in graphics processing operations. As also discussed above, if local frame buffer 28 is sufficiently sized so that the GART table and associated data may be stored therein, latency times may be sufficiently reduced or maintained within acceptable levels. But when the local frame buffer 28 is relatively small in size or is even nonexistent, then GPU 24 may then be configured to rely on system memory 20 for not only accessing the GART table stored for memory translations but also for retrieving data at the physical address corresponding to the virtual address referenced by the GART table.

FIG. 2 is a diagram of components in GPU 24 that may be included for minimizing the number of occurrences wherein GPU 24 attempts to access data or cache lines from system memory 20. As stated above, the fewer instances that the GPU 24 accesses the system memory 20 (in low or zero frame buffer configurations), the faster that GPU 24 can process graphical operations. Thus, the components of FIG. 2 are a number of many other, but nonshown, components of GPU 24.

Accordingly, GPU 24 may include a bus interface unit 30, that is configured to receive and send data and instructions. In one embodiment among others, the bus interface unit 30 may include a display read address translation component 31 configured to minimize access of system memory 20, as described above. The display read address translation component 31 of FIG. 2 is also described herein in conjunction with FIGS. 3 and 4, which comprise flow chart diagrams of the steps implemented by the display read address translation component 31.

In the nonlimiting example shown in FIG. 2 and described in FIGS. 3 and 4, in order to overcome long latency of the display read in a low or zero frame buffer graphic system, a pre-fetching based GART table cache system may be implemented. This nonlimiting example enables the minimization or even elimination of page table fetch latency on display read operations.

The components of the display read address translation component 31 may include a display read controller 32 that communicates with a page table cache (or a local cache) 34. The page table cache 34 may be configured to store up to, as a nonlimiting example, one entire display line of pages in tile format. A programmable register (not shown) may be used to set the size of the single display line depending upon the display resolution of the display, thereby adjusting the amount of data that may be stored in the page table cache 34. The register bits that may control the size of page table cache 34 may be implemented to correspond to the number of 8-tile cache lines to complete a display line, as one nonlimiting example.

Thus, in the process 50 of FIG. 3, a display read request may be received by display read controller 32 of FIG. 2, as shown in step 52. Along with the display read requests, a logical address corresponding to the data to be accessed may also be received by the display read controller 32. Thereafter in step 54, a hit/miss test component 38 (FIG. 2) that is coupled to display read controller 32 may determine whether the page table cache 34 does or does not contain the physical address corresponding to the logical address received in step 52. At least one purpose of this test is to determine whether the physical address is stored locally in the display read address translation component 31 or needs to be retrieved from the GART table stored in system memory 20. Thus, as shown in FIG. 3, the outcome of step 54 for hit/miss test component 38 has two results. One result is a “miss,” wherein the physical address is not contained in the page table cache 34. The other result is a “hit,” wherein the physical address corresponding to the received logical address in step 52 is contained in the page table cache 34.

In following the “miss” branch, step 56 follows, hit/miss test component 38 prompts the miss pre-fetch component 41 that operates to generate a cache request fetch command in this instance. The cache request is generated to retrieve the physical address corresponding to the received logical address. In step 58, the generated cache request fetch command is forwarded from the miss pre-fetch component 41 via the demultiplexer 44 to the northbridge 14, and onto to the system memory 20.

At the system memory 20, the GART table stored therein is accessed such that the cache data associated with the fetch command is retrieved and returned to GPU 24. More specifically, as shown in step 62, the cache request fetch command results in a number of cache lines being fetched from the GART table corresponding to a register variable in a programmable register entry, as described above. As one nonlimiting example, the register may be configured so that the page table cache 34 retains and maintains an entire display line for a display coupled to GPU 24.

Upon receiving the fetch cache lines from the GART table in system memory 20, the fetched cache lines are stored in the page table cache 34. Thereafter, in step 64, the display read controller changes the logical address associated to the fetched cache lines to the physical address in the local cache via hit/miss component 38. Thereafter, the physical address, as translated in step 64 by the hit pre-fetch component 42, is output by the demultiplexer 44 via northbridge 14 to access the addressed data, as stored in system memory 20 and corresponding to the translated physical address.

Steps 64 and 66, of the process 50 of FIG. 3, which may be implemented following step 62 for a “miss” result from step 54, may also be implemented following a “hit” result from step 54, as shown in FIG. 3. Thus, in returning to step 54, if the hit/miss test component 38 determines that the physical address is already contained in the page table cache 34, the result is a “hit.” As already discussed in step 64, the logical address received in step 52 is translated, or changed, to a physical address that is stored in the page table cache 34. The physical address is thereafter output from the hit pre-fetch component 42 via the demultiplexer 44 to northbridge 14 and onto access the data stored in system memory 20 corresponding to the physical address translated in step 64.

As stated above, the predetermined number of cache lines initially fetched in steps 56, 58, and 62 may be prescribed by a programmable register. Thus, an initial single page “miss” may result in an entire display line page address being retrieved and stored in the page table cache 34. However, with each subsequent hit/miss test performed in step 54, the result may be that the “hits” outweigh the “misses”, which may result is fewer accesses of system memory 20.

FIG. 5 is a diagram 80 of a display page address pre-fetching block diagram for the cache lines that may be stored in the page table cache 34 of FIG. 2. The initial access to 8-tile page address cache line 0 may result in a “miss” from step 54 of FIG. 3. Stated another way, when process 50 of FIG. 3 is initially executed, such that the page table cache 34 contains more of cache lines 80 of FIG. 5, the initial result of the hit/miss component 58 may result in execution of steps 56, 58 and 62, thereby retrieving cache lines 0-3 in FIG. 5, which may correspond to an entire display line.

Once all of the data contained in cache line 0 in FIG. 5 has been consumed and the process has moved on to cache line 1 of FIG. 5, the display read address translation component 31 may thereafter be configured to retrieve, or pre-fetch, a next cache line. In this nonlimiting example, the next cache line may be cache line 4. Thus, cache line 4 may be pre-fetched from system memory 20 in order to maintain a sufficient distance ahead of display read controller 32, which still has access to four cache lines, including cache lines 1-4. This prefetch scheme minimizes instances wherein the physical address from system memory 20, thereby resulting in decreased latency times.

As stated above, completion of cache line 0 moves the display read controller to cache line 1, but also shows the pre-fetching of cache line 4 (signified by the diagonal arrow extending from in cache line 1 to cache line 4). Similarly, upon completion of cache line 1, the display read controller 32 may move to cache line 2, thereby resulting in the prefetching of cache line 5, as signified by the diagonal arrow extending from cache line 2 to cache line 5. In this way, the page table cache 34 stays ahead of display read controller 32 in maintaining an additional display line of data so as to minimize the double retrieval of both the physical address and then the data associated with that address by GPU 24.

Returning to FIG. 4, process 50 may be continued so as to depict the pre-fetching of one additional cache line, as described immediately above. Upon completion of step 66 in FIG. 3, wherein a physical address may be output from the display read address translation component 31 for the accessing of data corresponding to the physical address in system memory 20, step 72 may follow. In step 72, a determination is made (which may be accomplished by hit/miss component 38) whether the current cache line being executed has been consumed or completed. This step 72 corresponds to whether cache line zero of FIG. 5 has been completed such that the display read controller moves to cache line 1, as described above. If not, process 50 may move to step 52 (FIG. 3) to receive the next display read request and logical address for execution.

Nevertheless, when cache line 0, in this nonlimiting example, is consumed (all data utilized), the result of decision step 72 may be a yes such that the display read controller 32 moves to the next cache line (cache line 1) stored in the page table cache 34. Thereafter, in step 74, a next cache request command is generated by hit pre-fetch component 42 so as to pre-fetch the next cache line. The hit pre-fetch component 42 forwards the next cache request command via demultiplexer 44 in BIU 30 of GPU 24 on to northbridge 14 and the GART table stored in system memory 20.

The next cache line, which may be cache line 4, is retrieved from the GART table and system memory 20 in this nonlimiting example. Cache line 4 is returned for storage in the page table cache 34. Thus, as described above, the diagonal arrows shown in FIG. 5 point to the next cache line that is pre-fetched upon the consumption of a prior cache line that has been pre-fetched and stored in the page table cache 34. In this way, as described above, the display read controller 32 is a able to maintain a sufficient number of cache lines in the page table cache 34 so as to translate any received logical address into the corresponding physical address. This configuration reduces the number of instances wherein the bus interface unit 30 accesses the physical address from system memory 20 and then again accesses the data associated with that physical address which otherwise results in dual retrievals and increased latency.

In continuing with this nonlimiting example, upon an initial “miss” from decision step 54 of FIG. 3, pages 0-3 may be fetched as a result of the implementation of steps 56, 58 and 62 of FIG. 3 such that the page table cache 34 may have four cache lines contained in its page table cache 34. However, upon the consumption of any single cache line, the hit pre-fetch operation corresponding to steps 74, 76 and 78 may result in the addition of one additional cache line, such as cache line 4 of FIG. 5 upon the consumption of cache line 0.

Subsequently, upon each “hit” in step 54, the determination may thereafter be made in step 72 (by hit/miss component 38) whether an additional cache line should be fetched from the GART table in system memory 20. If so, the result is that the hit pre-fetch component 42 may fetch one additional cache line, as shown in steps 74, 76, and 78. Thus, the page table cache 34 may always retain, in this nonlimiting example, a prescribed amount of physical addresses locally, thereby staying ahead of processing and minimizing the number of double data fetching operations, which slows processing operations.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

1. A method for a graphics processing unit (“GPU”) to maintain page table information stored in a page table cache, comprising the steps of:
receiving a display read request with a logical address corresponding to data to be accessed;
determining whether the page table cache in the GPU contains a physical address corresponding to the logical address;
generating a cache request fetch command if the page table cache does not contain the physical address corresponding to the logical address that is communicated to a memory coupled to the GPU;
returning a predetermined number of cache lines from a table in the memory to the GPU;
converting the logical address to the physical address; and
obtaining data associated with the physical address from the memory.

2. The method of claim 1, wherein the cache request fetch command is not generated if the page table cache does contain the physical address corresponding to the logical address.

3. The method of claim 1, wherein the predetermined number of cache lines returned corresponds to a programmable register entry.

4. The method of claim 1, wherein the predetermined number of cache lines returned is a number that corresponds to an entire display line for a display unit coupled to the GPU.

5. The method of claim 1, further comprising the step of:
generating a next cache request command to pre-fetch a next cache line from the memory.

6. The method of claim 5, wherein the next cache request command is generated when a previously fetched cache line in the page table cache is consumed.

7. The method of claim 1, wherein the table in the memory is a graphics address remapping table.

8. The method of claim 1, wherein the cache request fetch command communicated to the memory routes from the GPU to a system controller via a first high speed bus and to a system memory via a second high speed bus.

9. The method of claim 1, wherein the GPU has no local frame buffer.

10. A graphics processing unit (“GPU”) coupled to a system controller that is coupled to a memory of a computer, comprising:
a display read controller that receives a display read request containing a logical address corresponding to data to be accessed;
a local cache configured to store a predetermined number of cache lines corresponding to noncontiguous memory portions in the memory of the computer;
a test component coupled to the display read controller configured to determine if a physical address corresponding to the logical address associated with the display read request is contained in the local cache;
a first prefetch component configured to generate a cache request fetch command to retrieve a predetermined number of cache lines from a table in the memory of the computer if the test component outputs a result associated with the local cache not containing the physical address corresponding to the logical address associated with the display request; and
a second prefetch component configured to generate a next cache request command if a cache line contained in the local cache is consumed, wherein a next cache line is fetched from the memory of the computer.

11. The GPU of claim 10, further comprising:
a system controller coupled between the GPU and the memory of the computer, wherein the system controller routes the display read request received from a processor coupled to the system controller to the GPU.

12. The GPU of claim 10, further comprising:
a programmable register configured to establish the predetermined number of cache lines retrieved in association with the cache request fetch command to be a number of cache lines that corresponds to an entire display line on a display coupled to the GPU.

13. The GPU of claim 10, wherein the second prefetch component is configured to generate a next cache request command so as to maintain a number of cache lines in the local cache corresponding to an entire display line on a display coupled to the GPU ahead of a current processing point in the GPU.

14. The GPU of claim 10, further comprising:
a demultiplexer coupled to the first and second prefetch components and the display read controller and configured to output communications that are forwarded to the system controller.

15. A method for minimizing access of system memory in a computing system with a GPU lacking a local frame buffer, comprising the steps of:
determining whether a physical address that is associated with graphics related data in memory and that corresponds to a received logical address is or is not contained in a page table cache of the GPU, wherein the received logical address is converted to the physical address if contained in the page table cache;
generating a cache request to retrieve a predetermined number of cache pages from a memory coupled to the GPU if the physical address corresponding to the received logical address is not contained in the page table cache; and
generating a next cache request command to retrieve a number of cache pages from the memory when one or more cache pages in the page table cache is consumed so that the local GPU cache retains the predetermined number of cache pages in the page table cache.

16. The method of claim 15, wherein the predetermined number of cache pages are retrieved from a GART table in the memory.

17. The method of claim 15, wherein the page table cache is contained in a bus interface unit of the GPU.

18. The method of clam 15, further comprising the step of:
retrieving data associated with the physical address from the memory.

19. The method of claim 15, further comprising the steps of:
converting the received logical address to the physical address after the predetermined number of cache pages are retrieved from the memory.

20. The method of claim 15, wherein the predetermined number of cache lines corresponds to one entire display line on a display coupled to the GPU.
